(19) United States
(12) Patent Application Publication
(10) Pub. No.: US 2026/0156442 A1
(43) Pub. Date: Jun. 4, 2026

(54) METHODS FOR SENDING SITUATIONAL INFORMATION TO A PSAP

(71) Applicant: T-Mobile Innovations LLC, Overland Park, KS (US)

(72) Inventor: Hang Hoi YAU, Sammamish, WA (US)

(21) Appl. No.: 18/965,206

(22) Filed: Dec. 2, 2024

(51) Int. Cl. H04W 4/90; H04L 65/1045

(52) U.S. Cl. CPC H04W 4/90; H04L 65/1045

(57) ABSTRACT

Methods are provided for transmitting a call from a wireless device to a public safety access point (PSAP), receiving from the PSAP a request for situational information from the wireless device, generating situational information by the wireless device in response to the request from the PSAP, and transmitting using session initiation protocol (SIP), by the wireless device, the situational information to the PSAP using a wireless network.

### TECHNICAL BACKGROUND

Cellular phones, such as smartphones, are often used for contacting emergency services. In some instances, the emergency service is contactable by a public safety answering point (PSAP). When a PSAP is contacted, the caller verbally relays pertinent information, such as location, type of incident, and medical information, to the PSAP operator. Depending on the nature of the incident, the caller may have difficulty relaying information to the PSAP operator or may not be able to relay the information accurately, leading to incomplete information being given to emergency services and/or delays in aid being rendered to the caller.

### OVERVIEW

Exemplary embodiments described herein include methods for sending situational information to a public safety answering point (PSAP) over a wireless network. An exemplary method includes transmitting an emergency call to a PSAP from a wireless device over a wireless network. Once the emergency call is transmitted, the method includes receiving a request at the wireless device for situational information, with the request being received from the PSAP. In response to the request from the PSAP, the wireless device generates situational information. The method then further includes transmitting, by the wireless device, the situational information to the PSAP, with the situational information being transmitted using a wireless network. The situational information may be transmitted using session initiation protocol (SIP).

Another example method includes initiating an emergency call from a wireless device, with the emergency call being received at a public safety access point (PSAP). The method further includes gathering situational information and gathering medical information, with the situational information and the wireless information being gathered by the wireless device. Upon gathering the situational information and the medical information, the method includes transmitting an SOS support message from the wireless device to the PSAP. The SOS support message may be transmitted using SIP. The method then includes receiving an SOS invite using SIP at the wireless device, with the SOS invite being transmitted to the wireless device from the PSAP.

A further example method for sending situational information to a public safety answering point (PSAP) includes transmitting an emergency call from a wireless device to a PSAP. The method further includes determining that the wireless device supports situational information. Once the determination that the wireless device supports situational information has been made, the method includes receiving at the wireless device an SOS update request, with the SOS update request being received from the PSAP. In response to receiving the SOS update request at the wireless device, the method includes transmitting an SOS update to the PSAP by the wireless device. The SOS update is transmitted by the wireless device to the PSAP using a wireless network. The SOS update may be transmitted using SIP.

### BRIEF DESCRIPTION OF THE DRAWINGS

FIG. 1 illustrates an exemplary system for wireless device communication in accordance with disclosed embodiments.

FIG. 2 illustrates an additional exemplary system for wireless device communication with a PSAP in accordance with disclosed embodiments.

FIG. 3 illustrates an example method for sending situational information to a PSAP in accordance with disclosed embodiments.

FIG. 4 illustrates another example method for sending situational information to a PSAP in accordance with disclosed embodiments.

FIG. 5 illustrates another example method for sending situational information to a PSAP in accordance with disclosed embodiments.

### DETAILED DESCRIPTION

When an emergency call, such as a call to 911, is made, a public safety access point (PSAP) receives the call. More particularly, when an emergency call is made, the location of the device making the call is noted and based on the location, the call is routed to a PSAP that services the geographic area in which the call is being made. Because the PSAP is connected to a variety of emergency services, such as police, fire, and emergency medical service (EMS), the PSAP is able to coordinate aid to the caller.

During the emergency call, the PSAP will collect information such as type of emergency, additional situational information (e.g., location, status of the caller, weather at the scene), and medical information. Depending on the emergency situation, the caller may be unable to provide some or all of this information. For example, if a caller is in an unfamiliar location, providing specific location information to the PSAP may be difficult. In addition, the caller may be disoriented or otherwise unable to clearly and/or correctly give information to the PSAP. Because the information received at the PSAP is relayed to the emergency service responders, incomplete or unclear information can hinder the ability of the emergency responders to efficiently locate the caller and render aid.

Some wireless devices include the ability to gather situational data such that, in an emergency situation, the wireless device can compile additional information, including status of the wireless device when the emergency occurred (for example, whether the device was connected to vehicle Bluetooth® in a vehicle accident) or specific location and related information (e.g., weather). In addition, the wireless device may be coupled to external devices having the ability to gather medical information, and this medical information may be gathered by the wireless device as well. Currently, however, even when a wireless device is able to gather and compile situational information, the caller is still the primary means by which information is conveyed to the PSAP.

Exemplary embodiments described herein include methods for sending situational information from a wireless device to a PSAP. For example, once the wireless device transmits a call to a PSAP, the PSAP may send a request for situational information to the wireless device. If the wireless device supports gathering situational information, the wireless device may then generate and compile the situational information requested by the PSAP. Once all the requested situational information is compiled, the wireless device can use a wireless network to transmit the compiled information to the PSAP. In some examples, the compiled information may be transmitted to the PSAP using session initiation protocol (SIP). This may allow the PSAP to receive current and accurate information that can be used to provide important information to the emergency responders.

This action sequence does not preclude a person from directly relaying information to emergency services, such as a PSAP, nor is a PSAP mandated to request situational information from a wireless device that is making an emergency call. Rather, the methods discussed herein allow information to be relayed to the PSAP in a more streamlined manner while reducing the likelihood of incorrect or incomplete information being relayed. This facilitates efficient communications and ensures accurate information is given to the PSAP, as well as ensuring that emergency responders are equipped with updated and correct information when being dispatched to render aid to the caller.

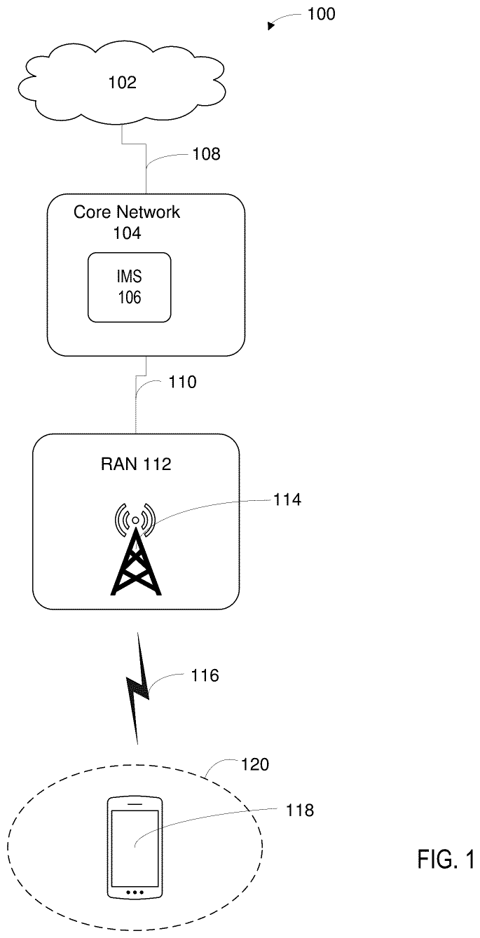

These and other examples will be described in greater detail below in relation to FIGS. 1-5.

FIG. 1 depicts an exemplary system 100 for wireless communication. System 100 includes a communication network 102, a core network 104 and a radio access network (RAN) 112, including at least one access node 114. The RAN 112 may include other devices and additional access nodes. Although one access node is shown, any number of access nodes may be included.

System 100 also includes a wireless device 118, which may be an end-user wireless device and may operate within a coverage area 120. The wireless device 118 may communicate with an access node 114 within the RAN 112 over a communication link 116, which may for example be 4G NR communication links.

Communication network 102 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 102 can be capable of carrying data, for example, to support voice, push-to-talk, broadcast video, and data communications by wireless device 118. Wireless network protocols can comprise Fifth Generation mobile networks or wireless systems (4G or 4G LTE). Wired network protocols that may be utilized by communication network 102 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 102 can also comprise additional base stations, controller nodes, telephony switches, internet routers, network gateways, computer systems, communication links, or some other type of communication equipment, and combinations thereof.

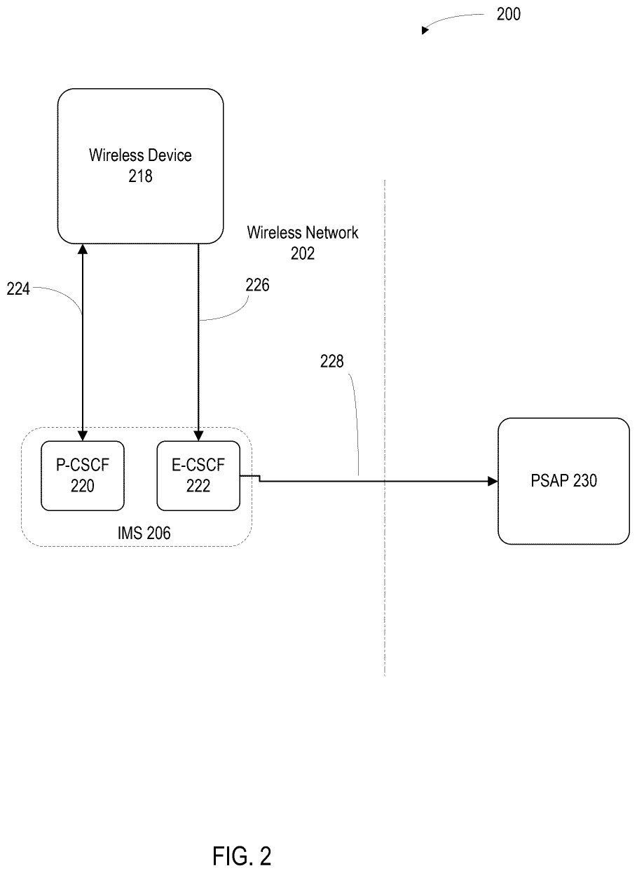

The core network 104 includes the IP Multimedia Subsystem (IMS) 106, which will be explained further in relation to FIG. 2. The core network 104 may be separated into user plane functions and control plane functions. The user plane accesses a data network, such as network 102, and performs operations such as packet routing and forwarding, packet inspection, policy enforcement for the user plane, quality of service (QoS) handling, etc. The control plane handles radio-specific functionality that depends on the idle or connected states of the wireless device 118.

Core network 104 includes an IP multimedia subsystem (IMS) 106. IMS 106 as used herein is a framework used for delivering IP multimedia services, such as voice over internet protocol (VoIP) and/or other similar services, across a network. IMS 106 may include a call session control function (CSCF). The CSCF as used herein is a component of IMS 106 used for session control, signaling and routing in multimedia communication. In embodiments, the CSCF may be used for handling session initiation protocol (SIP) communication. In embodiments, IMS 103 may be used for communication between entities or components of network 102 and wireless device 120. For example, the CSCF of the IMS 106 may be used for transmitting SIP communication to wireless device 118 and a PSAP. Communication links 108 and 110 can use various communication media, such as air, space, metal, optical fiber, or some other signal propagation path-including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links may use electromagnetic waves in the radio frequency (RF), microwave, infrared (IR), or other wavelength ranges, and may use a suitable communication protocol, including 4G including 4G NR or 4G Advanced, 6G, NTN, or combinations thereof.

Communication links 108 and 110 can be direct links or might include various equipment, intermediate components, systems, and networks, such as a cell site router, etc. Communication links 108 and 110 may comprise many different signals sharing the same link.

The RAN 112 may include an access network system and device such as access node 114. The RAN 112 is disposed between the core network 104 and the end-user wireless device 118. Components of the RAN 112 may communicate directly with the core network 104 and others may communicate directly with the end user wireless device 118. The RAN 112 may provide services from the core network 104 to the end-user wireless device 118.

The RAN 112 includes an access node (or base station) 114, which may include one or more access nodes communicating with the end-user wireless device 118. It should be understood that the disclosed technology may also be applied to communication between an end-user wireless device and other network resources, such as relay nodes, controller nodes, antennas, etc. The RAN 112 may further comprise a non-terrestrial network (NTN) serving the multiple UEs by a radio frequency transmission provided by utilizing orbiting satellites that may be in communication with access nodes of a terrestrial network (TN). The satellites may include geosynchronous equatorial orbit (GEO) satellites, Medium Earth Orbit (MEO) satellites, and low Earth orbit (LEO) satellites. The NTN may include NTN nodes that are not stationed on the ground.

Access node 114 can be, for example, standard access nodes such as a macro-cell access node, a base transceiver station, a radio base station, an evolved NodeB (or eNodeB) in 4G or 4G LTE, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access node 114 may comprise a short range, low power, small-cell access node such as a microcell access node, a picocell access node, a femtocell access node. Access node 114 can be configured to deploy one or more different carriers, utilizing one or more RATs. Any other combination of access nodes and carriers deployed therefrom may be evident to those having ordinary skill in the art in light of this disclosure.

The access node 114 and servers in the IMS 105 may comprise a processor and associated circuitry to execute or direct the execution of computer-readable instructions. They may retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless device 118 may include any wireless device included in a wireless network. Wireless device 120 may include any device configured to send and receive messages over SIP. For example, the term “wireless device” may include a relay node, which may communicate with an access node. The term “wireless device” may also include an end-user wireless device, which may communicate with the access node through a relay node. The term “wireless device” may further include an end-user wireless device that communicates with the access node directly without being relayed by a relay node. Wireless device 118 may be any device, system, combination of devices, or other such communication platform capable of communicating wirelessly with access node 114 using one or more frequency bands and wireless carriers deployed therefrom. Wireless device 118 may be, for example, a mobile phone, a wireless phone, a wireless modem, a personal digital assistant (PDA), a voice over internet protocol (VoIP) phone, a voice over packet (VOP) phone, or a soft phone, a wearable device, an internet of things (IoT) device, as well as other types of devices or systems that can send and receive audio or data. The wireless device 118 may be or include high power wireless devices or standard power wireless devices.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless device 118.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the radio access network 112 and the core network 104.

Although one core network 104 is shown, multiple core networks 104 may be utilized. Alternatively, the single core network 104 may include a distributed, cloud-native, converged core gateway. Thus, the converged core gateway could connect a 4G LTE evolved packet core (EPC) to a 5G core network.

Communication links 108 and 110 can use various communication media, such as air, space, metal, optical fiber, or some other signal propagation path, including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 108 and 110 can be direct links or might include various equipment, intermediate components, systems, and networks, such as a cell site router, etc. Communication links 108 and 110 may comprise many different signals sharing the same link.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for sending situational information to a PSAP using SIP may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

Now referring to FIG. 2, an exemplary system 200 for sending situation information to a PSAP using SIP is presented. System 200 includes a wireless device 218. Wireless device 218 may be the same as wireless device 118. System 200 also includes wireless network 202. Wireless network 202 may include a RAN, core network and/or a communication network, which may be the same as, respectively, RAN 112, core network 104 and communication network 102. In some examples, wireless network 202 may be hosted by a mobile network operator (MNO).

The IMS 206 includes servers, including a proxy call session control function (P-CSCF) 220 and an emergency call session control function {E-CSCF) 222, shown, but it should be understood that there are many other types of IMS servers that are omitted for clarity. A proxy server, such as P-CSCF 220 receives a call request from a wireless device, as shown by arrow 224. Headers may be added to the call request in the form of SIP headers such as Resource Priority Header (RPH), X-MAV-RPH: 911, Orig. ID, and Attestation-Info. The call request may then be forwarded to an emergency call management server such as E-CSCF 222 for further processing, as shown by arrow 226. E-CSCF 222 may query a gateway mobile location center (GMLC) for information about the destination network of the call. The GMLC returns information on a public safety access point (PSAP) 230 that services the location of the wireless device that originated the call request. This information includes how to contact the PSAP 230. The wireless device 218 is then connected to the PSAP 230. PSAP 230 may use SIP trunking to connect to IMS 206, which allows PSAP 230 to send and receive voice and multimedia data over an IP network. PSAP 230 may use SIP and session description protocol (SDP) for managing session and session parameters.

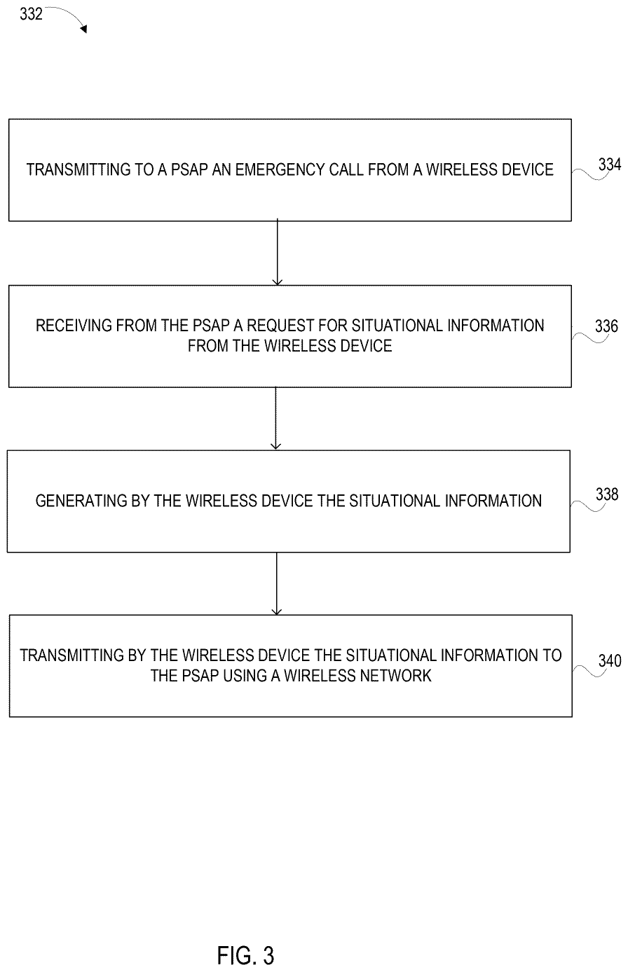

FIG. 3 illustrates an example method 332 for sending situational information to a PSAP in accordance with disclosed embodiments. Method 332 may be performed by any suitable combination of processors discussed herein, for example a processor contained in an emergency call management server, such as an E-CSCF server.

Method 332 begins in step 334 where an emergency call is transmitted to a PSAP from a wireless device. The emergency call may be transmitted via a wireless network, which may be hosted by a mobile network operation (MNO). In some examples, the emergency call is a session initiation protocol (SIP) invite. In embodiments, the CSCF transmits an SIP INVITE from the wireless device 220 to the PSAP 230 or vice versa. In embodiments, the SIP INVITE may include session description protocol (SDP) parameters that establishes an IMS DC for the session.

Method 332 continues in step 336 where the wireless device receives, from the PSAP, a request for situational information. The wireless device response is transmitted using an IMS DC. An IMS DC refers to a content-agnostic data transmission tunnel that uses SIP and IP Multimedia Subsystem (IMS) to carry multimedia services over an IP network. In an embodiment, the situational information is transmitted using a SIP or SOS UPDATE transmitted by wireless device 118 to the PSAP. For example, wireless device 220 may transmit an SIP or SOS UPDATE that includes SDP with parameters establishing the IMS DC and subsequently transmitting the situational information using the IMS DC.

The request for situational information may more particularly include a request for situational information gathered by the wireless device. In some examples, the request for situational information may be based on a determined category for the emergency call. Said differently, the PSAP may determine a classification for the emergency call (e.g., a motor vehicle accident). Based on that determined category, the PSAP may determine that specific types of information are likely to aid emergency responders and, thus, the request for situational information that is received at the wireless device may be based on the determined category of the emergency call. For example, the emergency call may be determined to be a motor vehicle crash, and the wireless device may receive a request for situational information that includes related information, such as connection status of the wireless device to the motor vehicle or specific location considerations (e.g., whether the motor vehicle crash occurred on a highway or a city street). Examples are not so limited, however, and other categories of emergency call may be used, with other categories including different situational information request considerations.

At step 338, method 332 includes generating the situational information by the wireless device. The situational data may be generated in response to the received request for situational information, received at step 336. In some examples, the situational information comprises sensor or media information generated by the wireless device. For example, the situational information may include temperature, orientation, or motion information, which may be generated using sensors within the wireless device. In embodiments, situational data may be generated by sensors and may include data generated based on user data and environmental data sensors. User data sensors may include sensors configured to detect data related to the wireless device, and user interaction with the device. For example, user data sensors may include accelerometers, gyroscopes, proximity sensors, touchscreen sensors, fingerprint sensors, face recognition sensors, and the like. Environmental data sensors may include sensors configured to capture data related to the environment within and around the wireless device. For example, environmental data sensors may include ambient light sensors, thermometers, hygrometers, air quality sensors, ultraviolet (UV) sensors, global position systems (GPS), barometers, and the like. In some embodiments, wireless device 118 may be configured to generate device data using sensors coupled to external devices.

In addition, or in the alternative, the situational information may include information about applications that were open at the time of the emergency or a photograph taken by the wireless device to show the current environment. Examples are not so limited, however, and other sensor and/or media information may be generated by the wireless device. In some examples, the particular situational information generated by the wireless device may be guided by the situational information requested by the PSAP in step 336.

Method 332 continues in step 340 with the transmission of the situational information using SIP to the PSAP. The situational information may be transmitted to the PSAP by the wireless device and may be transmitted using a wireless network. In some examples, the situational information may be transmitted to the PSAP using SIP.

In some examples, method 332 includes receiving an SOS invite from the PSAP at the wireless device. The SOS invite may include an invitation from the PSAP to the wireless device to share situational information from the wireless device with the PSAP. In some examples, the SOS invite may be received at the wireless device from the PSAP using an SIP method. Upon receiving an SOS invite from the PSAP, the wireless device may transmit the situational information in an SOS update. Said differently, the wireless device may transmit to the PSAP the requested situational information in response to receipt of an SOS invite. In some examples, the situational information is session description protocol (SDP) and is carried by the SOS update. In other examples, the situational information is transmitted to the PSAP using SIP.

Method 332 may further include receiving a permission invite from the PSAP at the wireless device. The permission invite from the PSAP may include a request from the PSAP for additional authorizations from the wireless device to the PSAP. Said differently, the permission invite may include a request that the PSAP be permitted to further engage with the wireless device. In response to receiving the permission invite from the PSAP, the wireless device may transmit a response to the permission invite to the PSAP. This response may grant the PSAP permission to interact with the wireless device. For example, the PSAP may be granted permission to activate a camera on the wireless device to look at the environment in which the emergency situation is occurring or may be granted permission to review medical information and contacts stored on the wireless device, as examples. The specific interactions between the PSAP and the wireless device may depend on the category of emergency call as previously determined.

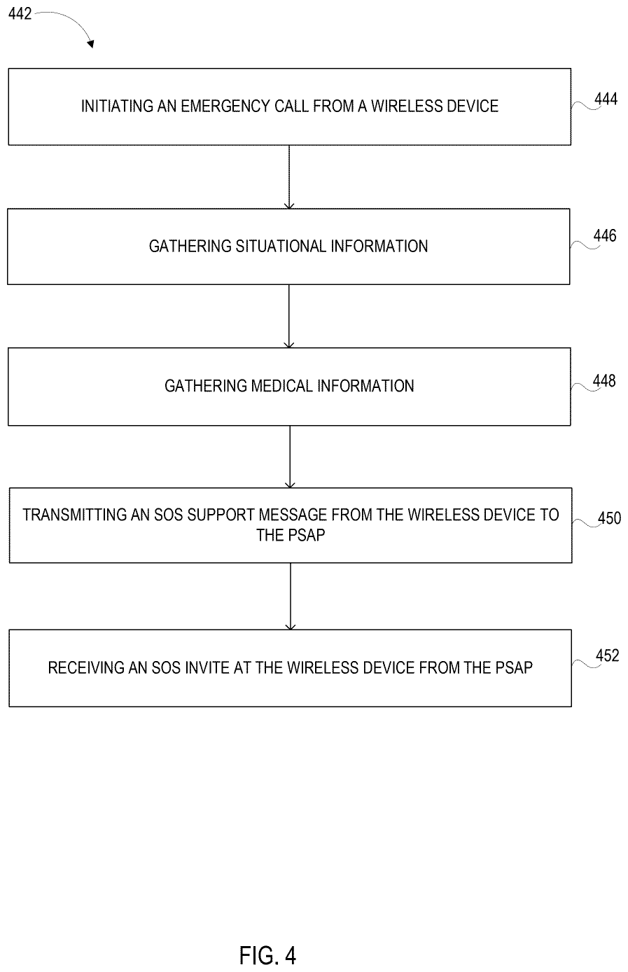

FIG. 4 illustrates an exemplary method 442 of sending situational information to a PSAP in accordance with disclosed embodiments. Method 442 may be performed by any suitable combination of processors discussed herein, for example a processor contained in an emergency call management server, such as an E-CSCF server.

Method 440 begins in step 444 where an emergency call is initiated by a wireless device. The emergency call may be received at a public safety access pint (PSAP). In some examples, the call may be received at a PSAP that is relatively geographically local to the location of the wireless device, with the particular PSAP being determined by the location of the wireless device being used to initiate the emergency call. For example, as discussed with respect to FIG. 1, the MNO may include at least one access point associated with a RAN, and the wireless device may interact with the access point. Because the access point is at a known geographic location, the geographic location of the wireless device may be determined such that a local PSAP receives the call.

Method 442 continues in step 446 with gathering situational information by the wireless device. As described with respect to FIG. 3, the situational information may include gathering information using sensors integrated with the wireless device. In some examples, gathering situational information at step 446 may include gathering weather information, such as temperature, precipitation, cloud cover, wind speed and direction, or any other desired weather information. Gathering situational information at step 446 may also include gathering location information, which may include global positioning system (GPS) coordinates, terrain information, landmarks, or other location information. In addition, gathering situational information at step 446 may further include gathering mobility information. Mobility information may include orientation of the wireless device, change in location over a period of time (i.e., whether the caller has moved with the wireless device), or any other mobility information.

At step 448, method 442 includes gathering medical information by the wireless device. In some examples, the medical information may be gathered using medical information stored on the wireless device in, for example, a health application. In other examples, gathering medical information at step 448 may comprise gathering information from a third-party device that is paired with the wireless device. For example, a wearable such as a smart watch may be paired with the wireless device and certain types of health information (e.g., heart rate, respiration, oxygen saturation) may be measured by the wearable and stored within a corresponding application on the wireless device. The medical information measured and stored therein may be gathered by the wireless device.

Method 442 continues at step 450 where the wireless device transmits an SOS support message to the PSAP. Transmitting an SOS support message to the PSAP from the wireless device may further comprise transmitting a message indicating support of situational information by the wireless device. Said differently, the wireless device may transmit an SOS support message to the PSAP to alert the PSAP that the wireless device can gather and compile situational information as part of an emergency call.

At step 452, method 442 includes receiving an SOS invite at the wireless device from the PSAP. The SOS invite may be received at the wireless device in response to the wireless device transmitting an SOS support message in step 450. In some examples, in response to receiving an SOS invite, the wireless device may validate the SOS invite. Said differently, the wireless device may confirm the authenticity of the SOS invite received from the PSAP. This validation may further include determining a type of information requested by the PSAP, with the type of information being related to a category of the emergency call, as described previously with respect to FIG. 3.

Once the SOS invite is validated at the wireless device, method 442 may further include transmitting an SOS update from the wireless device to the PSAP in response to the validation. More particularly, transmitting an SOS update may further comprise transmitting situational and medical information from the wireless device to the PSAP. In some examples, the particular situational and medical information transmitted by the wireless device to the PSAP may correspond to the type of information requested in the SOS invite by the PSAP, as determined by the wireless device. In some examples, the requested information may be transmitted from the wireless device to the PSAP using a session description protocol (SDP) method. In other examples, the requested information may be transmitted from the wireless device to the PSAP using SIP.

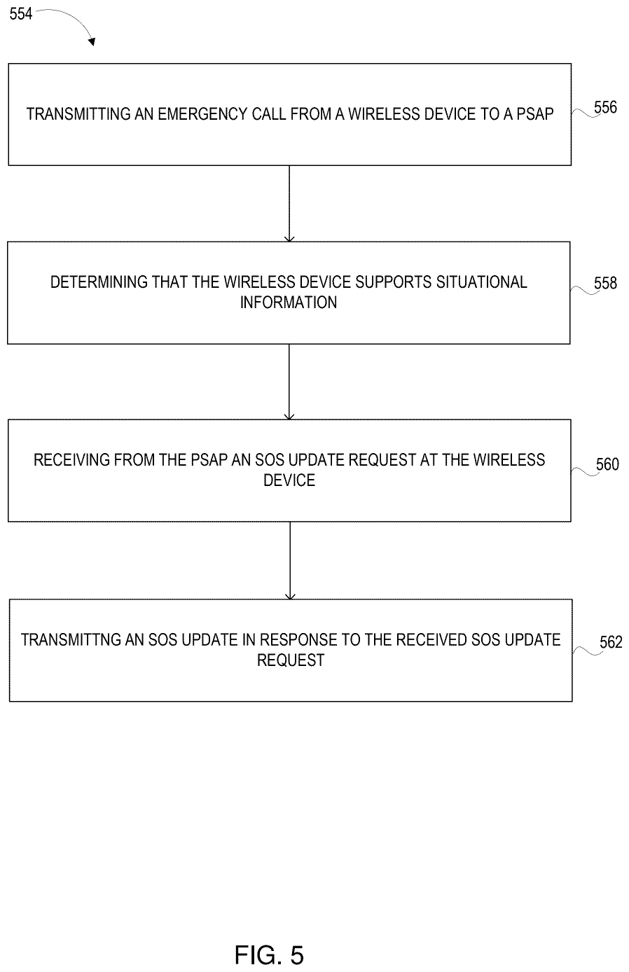

FIG. 5 illustrates another exemplary method 554 for sending situational information to a PSAP in accordance with disclosed embodiments. Method 554 may be performed by any suitable combination of processors discussed herein, for example a processor contained in an emergency call management server, such as an E-CSCF server.

Method 554 begins in step 556 where an emergency call is transmitted from a wireless device to a public safety access point (PSAP). In some examples, the emergency call is transmitted by a wireless network. The wireless network may be hosted by a mobile network operator (MNO).

Method 554 continues at step 558 where it is determined that the wireless device supports situational information. As described previously, determining that the wireless device supports situational information includes determining that the wireless device supports the gathering, generation, and/or compilation of information using sensors, media, or other sources of information contained within or adjacent to (e.g., paired with) the wireless device.

At step 560, method 554 includes receiving an SOS update request at the wireless device from the PSAP. The SOS update request may include a request to the wireless device to provide a desired set of information to the PSAP, with the desired set of information being based on a determined category of the emergency call. Said differently, the emergency call transmitted at step 556 may be classified at the PSAP and, based on that classification, the SOS update request that is received at step 560 may be tailored for the category of the emergency call, with the information being requested corresponding to the category of emergency call and information that emergency responders would find useful in responding to call.

Method 554 continues at step 562 with transmitting an SOS update by the wireless device. The SOS update may be transmitted by the wireless device to the PSAP in response to the SOS update request received at step 560. In some examples, transmitting an SOS update may further comprise gathering desired situational information and gathering desired medical information, with the desired situational information and medical information corresponding to the desired set of information provided as part of the SOS update request. Once the desired situational information and desired medical information is gathered, the information may be transmitted from the wireless device to the PSAP as part of the SOS update. In some examples, the SOS update may be transmitted by the wireless device using a wireless network. More particularly, in some examples, the desired set of information may be transmitted as part of an SOS update that is transmitted using a session description protocol (SDP) method. In other examples, the desired set of information may be transmitted to the PSAP using SIP.

In some examples, method 554 further includes receiving, at the wireless device, a subsequent SOS update request from the PSAP. The subsequent SOS update request may include a permission request from the PSAP to control the wireless device. In response to receiving the subsequent SOS update request from the PSAP, the wireless device may transmit a response to the PSAP. The response may include a response to the permission request and may grant control of the wireless device to the PSAP. As described with respect to FIG. 3, the PSAP may be granted permission to activate and engage with various applications on the wireless device, such as a camera, a health application, a wearable application, or any other application on the wireless device, with the specific interactions between the PSAP and the wireless device depending on a category of emergency call.

In some embodiments, methods 332, 442 and 554 may include additional steps or operations. Furthermore, the methods may include steps shown in each of the other methods. As one of ordinary skill in the art would understand, the methods of 332, 442 and 554 may be integrated in any useful manner and the steps may be performed in any useful sequence.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, comprising:
transmitting to a public safety access point (PSAP) an emergency call from a wireless device;
receiving from the PSAP a request for situational information from the wireless device;
responsive to the request from the PSAP, generating, by the wireless device, situational information; and
transmitting using session initiation protocol (SIP), by the wireless device, the situational information to the PSAP using a wireless network.

2. The method of claim 1, further comprising receiving an SOS invite from the PSAP at the wireless device using SIP.

3. The method of claim 1, further comprising transmitting the situational information in an SOS update to the PSAP.

4. The method of claim 3, wherein the situational information is session description protocol (SDP) carried by the SOS update.

5. The method of claim 1, further comprising:
receiving a permission invite using SIP from the PSAP at the wireless device; and
transmitting to the PSAP a response to the permission invite.

6. The method of claim 5, wherein the situational information is transmitted to the PSAP via an IP multimedia subsystem data channel (IMS DC).

7. The method of claim 1, wherein receiving the request for situational information is based on a determined category for the emergency call.

8. The method of claim 1, wherein the emergency call comprises a session initiation protocol (SIP) invite.

9. The method of claim 1, wherein the situational information comprises sensor or media information generated by the wireless device.

10. A method, comprising:
initiating an emergency call from a wireless device, wherein the emergency call is received at a public safety access point (PSAP);
gathering, by the wireless device, situational information;
gathering, by the wireless device, medical information;
transmitting an SOS support message from the wireless device to the PSAP, wherein the SOS support message is transmitted using session initiation protocol (SIP); and
receiving an SOS invite at the wireless device from the PSAP using SIP.

11. The method of claim 10, further comprising:
validating the SOS invite at the wireless device; and
transmitting an SOS update in response to validating the SOS invite.

12. The method of claim 10, wherein gathering situational data further comprises:
gathering weather information;
gathering location information; and
gathering mobility information.

13. The method of claim 12, wherein gathering medical information further comprises gathering information from a third-party device, wherein the third-party device is paired with the wireless device.

14. The method of claim 11, wherein transmitting an SOS support message from the wireless device to the PSAP further comprises transmitting a message indicating support of situational information by the wireless device.

15. The method of claim 11, wherein transmitting an SOS update further comprises:
determining, based on the received SOS invite, a type of information requested by the PSAP; and
transmitting the requested information from the wireless device to the PSAP using SIP, wherein the SIP is transmitted via an IP multimedia subsystem data channel (IMS DC).

16. The method of claim 9, wherein transmitting an SOS update further comprises transmitting situational and medical information from the wireless device to the PSAP.

17. A method, comprising:
transmitting an emergency call from a wireless device to a public safety access point (PSAP);
determining that the wireless device supports situational information;
receiving from the PSAP an SOS update request at the wireless device, wherein:
the SOS update request includes a request for a desired set of information; and
the desired set of information is based on a determined category of the emergency call; and
transmitting an SOS update in response to the received the SOS update request, wherein:
the SOS update is transmitted by the wireless device to the PSAP using a wireless network; and
the SOS update is transmitted using session initiation protocol (SIP).

18. The method of claim 17, further comprising:
receiving a subsequent SOS update request at the wireless device from the PSAP, wherein the subsequent SOS update request includes a permission request to control the wireless device; and
transmitting to the PSAP a response to the permission request granting control of the wireless device.

19. The method of claim 17, wherein transmitting an SOS update further comprises:
gathering desired situational information;
gathering desired medical information; and
transmitting the desired situational information and the desired medical information.

20. The method of claim 17, wherein transmitting an SOS update comprises transmitting the desired set of information using via an IP multimedia subsystem data channel (IMS DC).
